(19) United States
(12) Patent Application Publication
(10) Pub. No.: US 2015/0202748 A1
(43) Pub. Date: Jul. 23, 2015

(54) SYSTEM FOR SPRINKLER HOUSING REMOVAL

(71) Applicant: William Michael Trudeau, Upland, CA (US)

(72) Inventor: William Michael Trudeau, Upland, CA (US)

(21) Appl. No.: 14/601,110

(22) Filed: Jan. 20, 2015

Related U.S. Application Data
(60) Provisional application No. 61/930,380, filed on Jan. 22, 2014.

(51) Int. Cl. B25B 13/54; B25B 13/48; B05B 15/00

(52) U.S. Cl. CPC B25B 13/54; B05B 15/00; B25B 13/481

(57) ABSTRACT

A tool, method, and system for the efficient and effective removal of sprinkler housings without additional tools. The tool comprises a hollow tubular elongated body having an exterior wall and an opening through the length of the body. The body has an upper and a lower portion; a stop on the exterior wall of the body, where the length of the stop is larger than the maximum diameter of the lower portion of the body below the stop; and a rib or groove on the exterior wall of the body for engaging an interior rib of a sprinkler housing.

### CROSS-REFERENCE TO RELATED APPLICATIONS

This application claims priority to U.S. provisional patent application No. 61/930,380, filed Jan. 22, 2014, which is incorporated by reference in its entirety herein for all purposes.

### BACKGROUND

Traditionally, when a user needed to remove a sprinkler housing for replacement, repositioning the height of the sprinkler or repair, the user digs out around the sprinkler housing to gain access to the connection between the housing and the piping system. This process can require vast amounts of time and requires a significant effort, even for a single sprinkler.

Products have attempted to solve this problem such as the solutions proposed by the RQT tool (www.rqt-tool.com) and at www.pciabilities.com. The RQT tool can remove the sprinkler housing without digging up the ground surrounding the body by using a spring loaded mechanism or a flat bar. The www.pciabilities.com tool grasps the cap of the sprinkler and using a downward force, the user can remove the sprinkler housing from the ground for replacement.

However, each of these tools has a significant disadvantage. The inlet of the sprinkler attaches to a supply line that supplies water to the sprinkler housing. Once the housing has been removed, debris and other foreign contaminants can fall into the supply line during replacement, such as dirt. The debris can cause difficulties in installation and can prevent a new sprinkler housing from operating by obstructing the flow of water necessary for the correct operation of the sprinkler. Furthermore, these prior art tools do not provide any assistance aligning a sprinkler housing to the piping system while the tool is engaged in the removal, repositioning, or attaching process.

Therefore, there is a need for a device and method for the efficient and effective removal of sprinkler housings without additional tools that does not have the disadvantages of the prior art.

### SUMMARY

The present invention overcomes the limitations of the prior art by providing a tool, system, and method for the efficient and effective removal of sprinkler housings without additional tools that prevents the problems inherent in the prior art.

The tool comprises a hollow tubular elongated body having an exterior wall and an opening through the length of the body. The body has an upper and lower portion; a stop on the exterior of the body, where the length of the stop is larger than the maximum diameter of the lower portion of the body below the stop; and a rib or groove for engaging an interior rib of a sprinkler housing connected to a piping system. The opening is sized to allow a rod or an irrigation tube to be placed through the body and into a point of contact with the sprinkler housing and the piping. The rod provides an alignment guide as well as plugging the hole left by removal of the sprinkler housing to prevent debris and foreign contaminants from entering the piping system.

The exterior wall of the top portion of the tool can be hex shaped for being engaged by a tool. Furthermore, the top can be a turning handle that is preferably detachable. On the interior wall proximate to the bottom of the tool can be another hex section. The hex allows for numerous tools to be attached to the bottom or top portion of the tool body to aid in the sprinkler housing removal.

The stop limits the distance the tool can move vertically into the sprinkler body and is preferably located between the upper and lower portions of the device. However, in one embodiment the ribs serve as a stop wherein the ribs of the device are stepped or different diameters. Stepped ribs comprise first and second sets of ribs, the first set of ribs being below the second set of ribs, the first set of ribs extending outwardly from the exterior wall of the body by a first distance, the second set of ribs extending outwardly from the exterior wall of the body by a second distance, the second distance being greater than the first distance.

Multiple embodiments are envisioned, such as a system comprising the tool with the rod, or a hollow tubular sleeve, or both. The rod can be fitted with a cap to plug the contact point between the sprinkler body and the piping system preventing debris and foreign contaminants from entering the piping system. The rod also serves as a guide for accurate placement of the removal tool into the sprinkler housing. Alternatively, due to the hex shape, a plug may be fitted to the bottom portion of the tool body to plug the piping.

The hollow tubular sleeve or an adapter has an exterior diameter that is sized to fit the interior diameter of larger diameter sprinkler housings. The top of the sleeve receives at least part of bottom portion of the tool. In one embodiment, the sleeve comprises the same ridges and opening as the sprinkler tool having the same functions.

The present invention further provides a method for removing a sprinkler housing having internal ribs connected to the piping system. The method comprises the steps of placing the rod through the sprinkler housing down into the piping system; placing the tool over the rod aligning the bottom portion of the tool inside the sprinkler housing; aligning the external ribs or grooves of the tool so that they engage the internal ribs of the sprinkler housing; and rotating the tool to release the housing from the piping system. The rotating can be done by hand, or with a tool, such as a channel lock, a custom tool, or with an open top where you can place a handle type device in the hole. The handle can also be permanently part of the tool, such as a t-handle. Optionally, the use of the rod is not necessary for the removal of the sprinkler housing and a plug may be fitted to the bottom portion of the tool when the rod is not being used.

Furthermore the invention provides a method for inserting an irrigation tube into the piping system comprising the steps of removing the sprinkler housing according to the first method of the invention; removing the tool from the housing; running an irrigation tube through the hole in the tool body; placing the irrigation tube and the tool together toward the piping system and rotating the tool to securely fasten the irrigation tube to the piping system; wherein the opening is sized so that a drip irrigation tube can be placed through the entire opening.

### DRAWINGS

These and other features, aspects and advantages of the present invention will become better understood with regard to the following description, appended claims, and accompanying figures where:

FIG. 1 is a perspective view of a system comprising a tool of the invention and a rod therein according to one embodiment of the present invention;

FIG. 2 is a top plan view of the tool of FIG. 1;

FIG. 3 is a bottom plan view of the tool of FIG. 1;

FIG. 4 is a longitudinal partial cross-sectional view of the tool of FIG. 1;

FIG. 5 is a perspective view of a sleeve/adapter for the tool of FIG. 1;

FIG. 6 is a top plan view of the sleeve of FIG. 5;

FIG. 7 is a bottom plan view of the sleeve of FIG. 5;

FIG. 8 is a longitudinal partial sectional view of the sleeve of FIG. 5;

FIG. 9 is a perspective view illustrating the union of the tool of FIG. 1 and the sleeve of FIG. 5;

FIG. 10 is a cross-sectional view illustrating the union of FIG. 9; and

FIG. 11 is a perspective view of a rod used with the sprinkler removal tool of FIG. 1, according to one embodiment of this invention.

### DESCRIPTION

The present invention overcomes the limitations of the prior art by providing a device and method for the efficient and effective removal of sprinkler housings without additional tools that prevents the problems inherent in the prior art.

All dimensions specified in this disclosure are by way of example only and are not intended to be limiting. Further, the proportions shown in these Figures are not necessarily to scale. As will be understood by those with skill in the art with reference to this disclosure, the actual dimensions and proportions of any system, any device or part of a system or device disclosed in this disclosure will be determined by its intended use. Well-known structures and techniques may not be shown in detail in order not to obscure the embodiments.

In the following description, certain terminology is used to describe certain features of one or more embodiments of the invention. The term “tool ribs” refers to the different size wings on the exterior wall of the tool that engage the sprinkler housing ribs for removal and tighten the sprinkler housing. The term “sprinkler ribs” refer to the internal ribs found inside a sprinkler housing that help provide alignment to the sprinkler nozzle as the sprinkler riser is forced upward by water pressure.

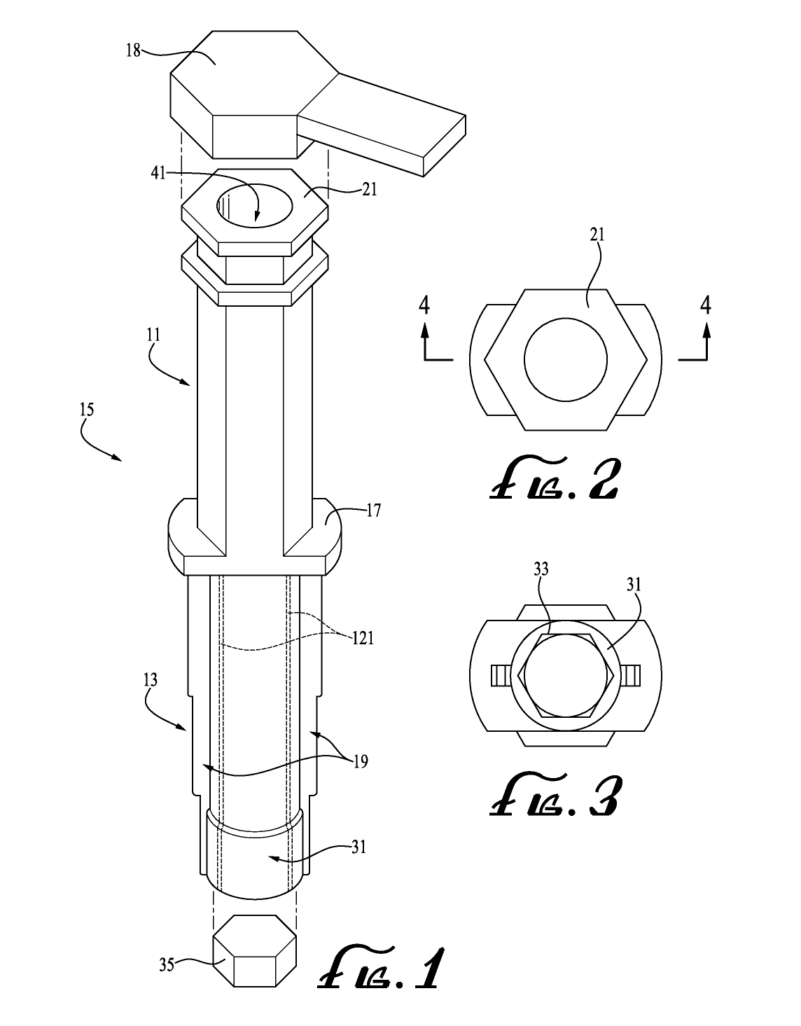

Referring now to FIG. 1, there is shown a perspective view of a system comprising a tool and a rod therein according to one embodiment of the present invention. The tool comprises a hollowing tubular elongated body 15 having an upper portion 11 and a lower portion 13. The hollow tubular elongated body 15 has an exterior wall and an opening 41 through the body 15. Furthermore, the tool comprises a rib 19 or groove 121 on the exterior wall of the body 15 wherein the exterior rib 19 engages an interior rib of the sprinkler housing 127. Preferably, the tool comprises at least two ribs 19 or two grooves 121. A stop 17 is disposed on the exterior wall of the tool body 15. The length of the stop 17 is larger than the maximum diameter of the lower portion 13 of the body 15. Preferably, the stop 17 is disposed on the exterior wall of the tool between the upper portion 11 and lower portion 13 of the body 15.

The stop 17 physically limits the distance the body 15 can move vertically into the sprinkler housing 127. This prevents the user from applying too much pressure or damaging the underlying piping. Furthermore, the stop 17 provides the user a mechanism in which to apply enough downward pressure to the sprinkler housing 127 in order that the user may unthread the housing from the underlying piping. In another embodiment, the tool rib 19 can be a stepped rib design that provides a stop mechanism for smaller diameter sprinkler bodies This stepped embodiment comprises a first set of ribs and second sets of ribs, the first set of ribs being below the second set of ribs, the first set of ribs extending outwardly from the exterior wall of the body by a first distance, the second set of ribs extending outwardly from the exterior wall of the body by a second distance, the second distance being greater than the first distance.

In one embodiment, the top portion 11 of the tool can comprise a slip fitting to attach to a PVC pipe. The pipe can be used with simple fittings such as a PVC cross fitting and outward extending pipe for handles. In this embodiment, the tool then comprises a simple easy to use t-handle as part of the tool. In another embodiment, a detachable handle 18 can be attached to the upper portion 11 of the body 15 providing a mechanism to grip and rotate the tool.

Referring to the preferred embodiment illustrated in FIGS. 1 and 2, the exterior wall of the top attachment portion 21 comprises a hexagonal shape so that standard channel locks or an adjustable wrench can be used to tighten or loosen the sprinkler housing 127. Additionally, the top attachment portion 21 can vary in length so that the tool can protrude high enough out of turf to be accessible for a wrench to engage the tool. Due to the hexagonal shape of the top attachment portion 21, separate tools can be attached such as a t-handle feature for ease of removal and tightening sprinkler housings 127.

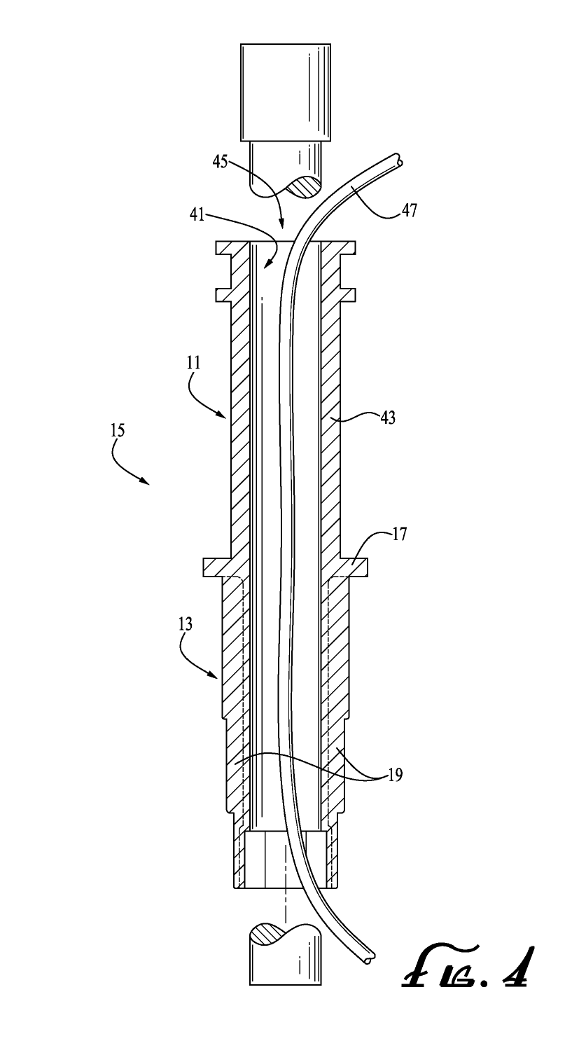

Referring to FIG. 3, optionally, the interior wall proximate to a bottom attachment portion 31 of the tool can comprise a hex section 33. This section must be close enough to the bottom end of the tool so that the hex 33 can still engage an attachment or underlying piping system. A removable mountable plug 35 can be attached the hex 33. The plug 35 can be inserted into the underlying piping to prevent debris from entering the piping. Furthermore, the plug 35 may be inserted to easily plug the line if the user does not wish to replace the sprinkler. Furthermore, because of the hex 33, other tools may be attached to aid in the sprinkler housing 127 removal and replacement, for example, an extension/riser removal tool may be attached to the hex 33 and inserted into the sprinkler housing 127 and/or piping system in order to remove a broken riser.

Referring now to FIG. 4, there is shown a longitudinal partial cross-sectional view of the tool of FIG. 1. As can be seen, tool comprises an external portion 43 and an internal portion 45. The exterior portion 43 of the tool comprises a diameter so that the tool can slip over a plugging and alignment rod 111 and fit inside the sprinkler housing 127. The internal portion 45 comprises an opening 41 through the tool body 15 providing an access point so that the tool can fit over a plugging and alignment rod 111, shown in FIG. 11. In one embodiment, the rod 111 comprises a removable mountable plug 113 attached to the bottom end of the rod. The rod 111 is passed through the sprinkler housing 127 and down into the point of attachment from the sprinkler and the piping system. The length of the rod 111 is sized to be able to pass through the entire length of the sprinkler housing 127 and attach to the piping system. Furthermore, the diameter of the opening 41 is sized so that a drip irrigation tube 47 can be placed through the entire opening. As can be appreciated, the opening 41 can be various sizes to accommodate a variety of plugging rods that fit snugly inside the water inlet pipes and sprinkler housings 127.

Referring now to FIGS. 1 and 4, the exterior wall of the body 15 comprises one or more than one exterior ribs 19 or grooves 121 for fitting into the sprinkler housing 127 and contacting the interior sprinkler ribs so that a force can be applied to the sprinkler ribs for removal and tightening of the sprinkler housing 127. The tool rib or ribs 19 can be either a step design to fit multiple sprinkler housings or a single use tool for a specific sprinkler housing 127. In this preferred stepped embodiment, there is the first and second sets of ribs 19, the first set of ribs being below the second set of ribs, the first set of ribs extending outwardly from the exterior wall of the body by a first distance, the second set of ribs extending outwardly from the exterior wall of the body by a second distance, the second distance being greater than the first distance. The tool can also be sized for different categories of sprinklers, such as, for example, spray sprinklers and rotor sprinklers.

In another embodiment, the one or more than one ribs are centered on the diameter of the exterior portion of the tool. As seen in FIGS. 1 and 4, the tool comprises two opposing ribs 19 comprised of a plurality of steps that are sized to fit a variety of sprinkler ribs. The tool of FIG. 1 comprises three steps of varying diameters on the ribs 19 providing one unitary tool that will fit three different standard sprinkler housings 127. As can be appreciated, the tool can also comprise a single rib size and diameter to work on a single type of sprinkler housing 127.

In another embodiment, the tool ribs 19 are offset from the center of the tool by an amount equal to ½ the thickness of the sprinkler housing 127. A first rib is off centered to one side and a second rib is off centered in the opposite direction by the same distance, which is ½ the thickness of the sprinkler ribs. This embodiment provides greater contact surface from the tool ribs 19 to the sprinkler ribs. The greater contact surface helps displace the applied force to the sprinkler housing. In a preferred embodiment, the off set for the tool ribs 19 provides the maximum torsion to aid in the removal of the sprinkler housing 127.

In another embodiment, the tool ribs 19 are replaced with a center groove or grooves 121 as illustrated in FIG. 1. The preferred embodiment comprises at least two grooves 121. The groove is designed to act as a slot to surround the sprinkler housing ribs 19 providing a greater amount of pressure to be applied to the sprinkler housing ribs and a more even contact surface. This embodiment is also bidirectional providing the capability of removing and tightening a sprinkler housing using a single set of tool grooves. Another embodiment may comprise both types of ribs 19 and grooves 121.

In another embodiment, the tool ribs 19 can be designed as a separate feature that can be added to an existing product for insertion into a sprinkler housing 127. For example, a torsion spring can be attached through a screwing action onto a male threaded adapter such as PVC. The torsion spring comprises arms that extend outward with a bend in the ribs. The rib bend can be between 45 and 120 degrees. In a preferred embodiment, the rib bend is 90 degrees. The bend is such that a first arm is created on one side of the tool pointing in an upward direction and a second arm pointing in a downward direction, where the tool is horizontal to the plane of the sprinkler housing 127. The first and second arms comprise a set distance apart and when inserted into a sprinkler housing 127 they fit snugly inside the sprinkler ribs. When the tool is rotated either a clockwise or counter-clockwise direction, the first and second arms contact the sprinkler ribs and transmit a force to rotate the sprinkler housing 127. The correct method of a selected rotation of the tool will tighten the torsion spring onto the male adapter and the opposite rotation will contact the opposing torsion spring arm, and this opposite rotation will also tighten the spring onto the male adapter fitting.

Referring now to FIG. 11, there is shown a perspective view of a dual purpose plugging and alignment rod 111 useful for the tool of FIG. 1. The plugging and alignment rod 111 is placed inside the sprinkler housing 127 and inserted into the connection point between the sprinkler housing and the piping system. In one embodiment, the plugging and alignment rod 111 can comprise two sizes on opposite ends of the plugging rod. In a preferred embodiment, the plugging and alignment rod comprises a first and a second end with a diameter of ¼″ to a ¾″ to fit in most standard piping systems used. Preferably, the plugging and alignment rod consists of a ½″ first end and a ⅝″ second end. However, other sizes are possible and the plugging and alignment rod can also comprise only a single size. In such an embodiment, a removable mountable plug 113 is attached to the bottom end of the rod 111. The rod 111 or the rod 111 with the plug 113 prevent debris and foreign contaminants from entering the piping system.

Preferably, the plugging and alignment rod 111 is placed through the inside the sprinkler housing 127 prior to using the tool to remove the housing 127. Therefore, the plugging and alignment rod 111 serves as a directional alignment tool for the removing, adjusting, and replacing of the sprinkler housing 127. The rod 111 can prevent cross threading of the sprinkler housing 127 with the piping system and insures proper angle for of the sprinkler. The plugging and alignment rod 111 can be made from any appropriate material suitable for use with the piping system. In a preferred embodiment, the plugging and alignment rod 111 can be made from plastic coated metal to provide enough mass to prevent water from the piping system from forcing the plugging and alignment rod out of the water inlet. However, the rod 111 is not necessary for the removal of the sprinkler housing 127. In such a system, a removably mountable plug 35 is inserted into the bottom attachment portion 31. The plug 35 can be sized to fit the 33 hex section of the tool body 15.

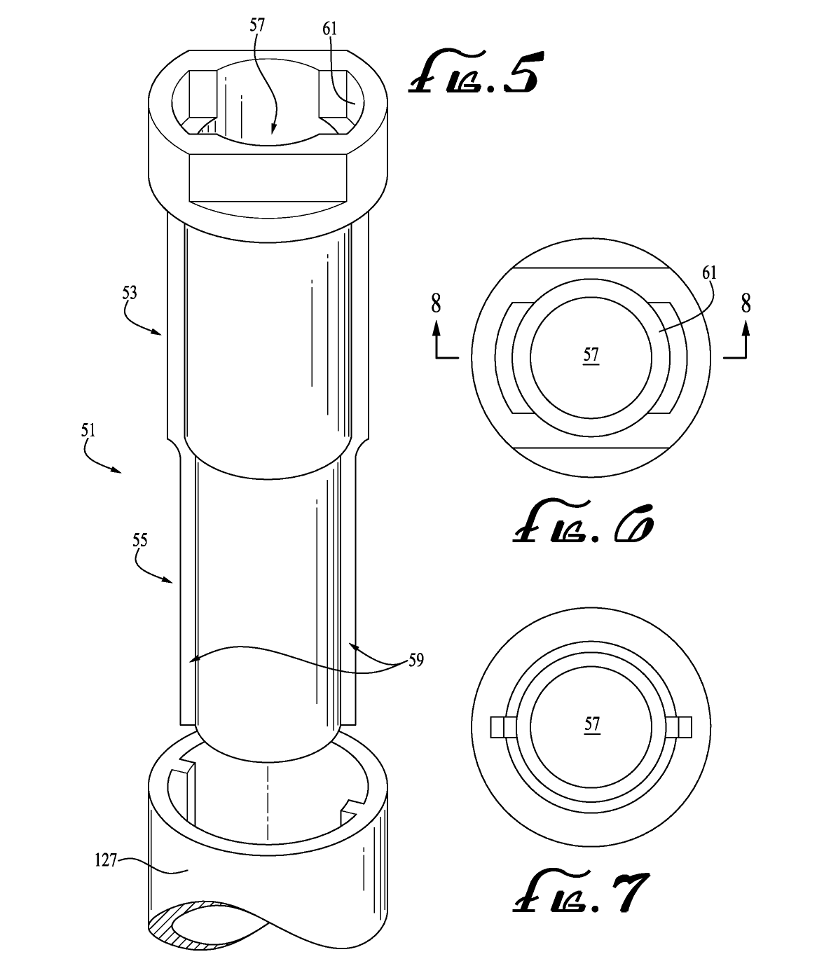

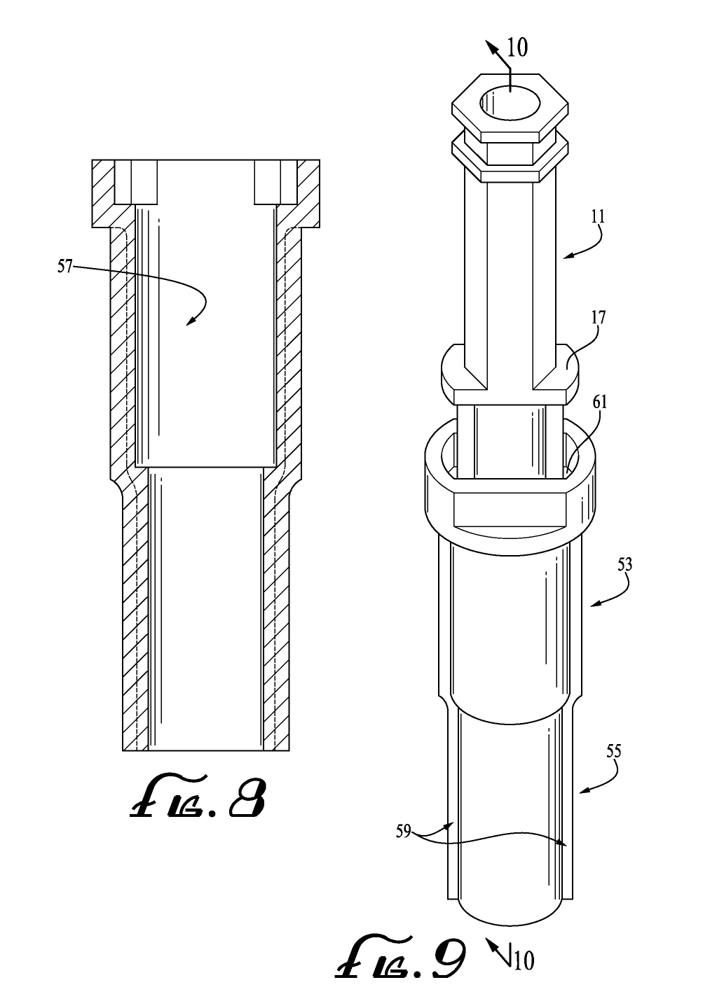

FIG. 5 illustrates a hollow tubular sleeve 51 according to one embodiment. The sleeve comprises and upper attachment portion 53 and a lower portion 55. On an exterior wall of the sleeve 51 is disposed a rib 59 or a groove 121 for engaging a rib in the interior of a sprinkler housing 127. The preferred embodiment comprises at least two ribs 59 or two grooves 121. The hollow tubular sleeve 51 receives at least part of the bottom portion 13 of the body 15. The sleeve 51 provides an adapter for the larger diameter sprinkler bodies. The diameter of the external wall of the sleeve is sized to the interior wall diameter of larger sprinkler housings 127. As seen in FIGS. 6 and 7, the interior portion 57 of the sleeve 51 is hollow to allow for the same functionality discussed above regarding the tool by providing access for the alignment and plugging rod 111. As seen in FIG. 8, the interior portion 57 of the sleeve provides the same functionality as the opening 41 of the tool. Furthermore, as seen in FIG. 5, the ribs 59 or the ribs 19 contact the ribs on the interior of the sprinkler housing 127.

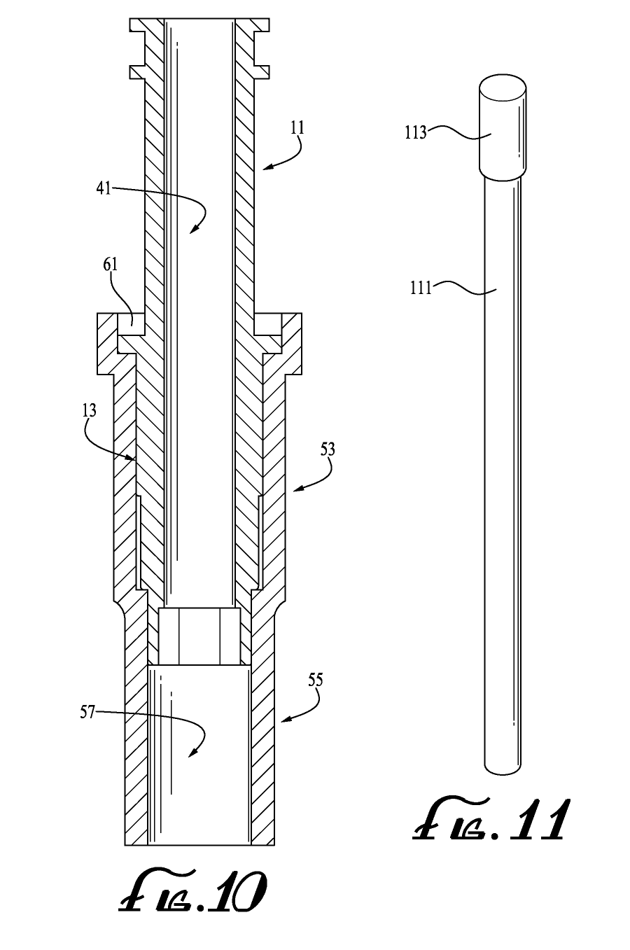

Now referring to FIGS. 9 and 10, there is a perspective and cross sectional view of the union of the lower portion 13 of the tool and the sleeve 51. As can be observed, the lower portion 13 fits snug into the sleeve 51 leaving the upper portion 11 protruding. As seen in FIGS. 5 and 6, the top attachment portion 53 of the sleeve 51 is a recessed female portion 61 that is structured to mate with the exterior stop 17 of the tool. In another embodiment, the union between the tool and the sleeve 51 can be accomplished through the mating of the ribs 19 with internal grooves on the sleeve 51. Once the user places the tool into the sleeve 51, aligning the stop 17 with the recessed female portion 61, the tool and the sleeve 51, act as one unit, thereby when the tool is rotated, the sleeve 51 is also rotated. The exterior ribs 59 function identically as the ribs 19, discussed above.

Another aspect of the invention is a method for using the tool to release the sprinkler housing 127 connected to the piping system. First, a sprinkler cap is removed by hand. Then, sprinkler components are removed leaving an empty sprinkler housing. Next, the plugging and alignment rod 111 is inserted into the piping system or a water inlet sealing and isolating the sprinkler housing 127 from the piping system and providing a guide for the placement of the new or repaired sprinkler. Then, the tool is placed over the plugging and alignment rod 111 and into the sprinkler housing 127. The tool is fitted snugly into the sprinkler housing and positioned to engage the ribs on the interior of the sprinkler housing 127. Then the tool is rotated to engage the sprinkler housing ribs to create the needed force to unthread the sprinkler from the piping system. Once the sprinkler housing 127 is separated from the piping system, the sprinkler housing 127 can be removed, the housing 127 can be lifted out of the ground after sufficient turns of the tool allowing the sprinkler housing 127 to be separated from the piping system. During the removal of the sprinkler housing 127, the tool and the sprinkler housing is lifted off the plugging and alignment rod 111 leaving the plugging and alignment rod inside the piping system to prevent debris and foreign contaminants from entering the piping system. Next, a new sprinkler housing 127 can be installed over the plugging and alignment rod 111 and pushed onto the point of connect to the piping system. Then, the tool is inserted into the sprinkler housing 127 by passing the tool over the plugging and alignment rod 111 to the appropriate step on the sprinkler removal tool ribs 19/59 or grooves 121 for a secure fit. Next, the tool is turned until the tool ribs 19/59 or grooves 121 are aligned with the sprinkler ribs. Then, the tool is turned to install the sprinkler housing onto the piping system. Next, the plugging and alignment rod 111 and the tool are removed from the sprinkler housing 127. Finally, the sprinkler can be reassembled.

Furthermore the invention provides a method for inserting an irrigation tube 47 into the piping system. The sprinkler housing 127 is first removed according the method described above leaving a vacant hole. Then after separating the tool from the sprinkler housing 127, an irrigation tube 47 is placed through the opening 41 in the tool body 15. The tool connected to the irrigation tube 47 is placed down into the vacant sprinkler housing hole toward the piping system. The tool connected to the irrigation tube 47 is rotated, us the tool as a wrench, to securely fasten the irrigation tube 47 to the piping system. After securely fastening the irrigation tube 47 to the piping system, the tool can be removed and the vacant hole filled.

Preferably, the device is rigid and of monocoque unitary construction but other embodiments are envisioned. Furthermore, the tool can comprise multiple opposing tools to accommodate using the tool on multiple variations of sprinkler housings in a single tool configuration. For example, one end of the tool can comprise a single purpose spray sprinkler removal tool and by rotating the tool 180 degrees the opposition part of the tool can comprise a rotor sprinkler removal tool. This provides manufactures with the capability of producing a single tool to cover a large number of sprinkler bodies. Conversely, the tool can comprise a single rib size and offset to work only on a single brand of sprinkler housing, such as, for example the Rainbird®, Toro® or Hunter® sprinklers. Different sprinkler housings have internal ribs offset by different degrees, such as three ribs offset by 120 degrees or two ribs offset by 180 degrees. Accordingly, the tool of the invention, specifically the number and location of the exterior ribs 19, can be made to match the different internal ribs of the sprinkler housings.

Although the present invention has been described with a degree of particularity, it is understood that the present disclosure has been made by way of example and that other versions are possible. As various changes could be made in the above description without departing from the scope of the invention, it is intended that all matter contained in the above description or shown in the accompanying drawings shall be illustrative and not used in a limiting sense. The spirit and scope of the appended claims should not be limited to the description of the preferred versions contained in this disclosure.

All features disclosed in the specification, including the claims, abstracts, and drawings, and all the steps in any method or process disclosed, may be combined in any combination, except combinations where at least some of such features and/or steps are mutually exclusive. Each feature disclosed in the specification, including the claims, abstract, and drawings, can be replaced by alternative features serving the same, equivalent or similar purpose, unless expressly stated otherwise. Thus, unless expressly stated otherwise, each feature disclosed is one example only of a generic series of equivalent or similar features.

Any element in a claim that does not explicitly state “means” for performing a specified function or “step” for performing a specified function should not be interpreted as a “means” or “step” clause as specified in 35 U.S.C. §112.

What is claimed is:

1. A tool suitable for removing a sprinkler housing connected to a piping system, the tool comprising:
a. a hollow tubular elongated body having an exterior wall and an opening through the length of the body, the body having an upper portion and a lower portion;
b. a rib or a groove on the exterior wall of the body for engaging an internal rib in the sprinkler housing; and
wherein the opening is sized so that a rod or a plug can be placed through the opening into the sprinkler housing to prevent debris from entering the piping system.

2. The tool of claim 1 comprising at least two ribs.

3. The tool of claim 2 further comprising a stop on the exterior wall of the body between the upper portion and the lower portion, wherein the length of the stop is larger than the maximum diameter of the lower portion of the body below the stop.

4. The tool of claim 2 wherein the top portion of the exterior wall of the tool is hex shaped for engagement by a tool.

5. The tool of claim 2 wherein the body upper portion has a turning handle.

6. A method for inserting an irrigation tube into a piping system, the method comprising the steps of:
a. placing the tool of claim 2 into the sprinkler housing with the tool ribs engaging the internal sprinkler housing ribs;
b. rotating the tool to release the sprinkler housing from the piping system and removing the housing from the piping system and withdrawing the tool;
c. placing an irrigation tube through the opening in the tool;
d. placing the tool and the irrigation tube together down toward the piping system; and
e. rotating the tool to securely fasten the drip irrigation tube to the piping system.

7. The tool of claim 2 wherein an interior wall proximate to the bottom portion of the body comprises a hex shaped section.

8. A system for removing a sprinkler housing comprising the tool of claim 2 and a hollow tubular sleeve sized to receive at least part of the bottom portion of the tool body therein.

9. The system of claim 8 wherein the sleeve comprises exterior ribs or grooves for engaging ribs in the sprinkler housing.

10. A system for removing a sprinkler housing comprising the tool of claim 2 and a rod having a length at least as large as the length of the body and sized to extend through the entire length of the opening in the tool body.

11. The system of claim 10 further comprising a plug removably mountable on the rod for insertion into the piping system for keeping debris from entering the piping system.

12. A system comprising the tool of claim 2 and a plug removably mountable on the bottom of the body of the tool.

13. The system of claim 12 wherein the plug is shaped to engage the bottom hex shaped section of the tool.

14. The tool of claim 2 comprising first and second sets of ribs, the first set of ribs being below the second set of ribs, the first set of ribs extending outwardly from the exterior wall of the body by a first distance, the second set of ribs extending outwardly from the exterior wall of the body by a second distance, the second distance being greater than the first distance.

15. A tool suitable for removing a sprinkler housing connected to a piping system, the tool comprising:
a. the tool of claim 1 comprising at least two sets of ribs;
b. a stop on the exterior wall of the body between the upper portion and the lower portion, wherein the length of the stop is larger than the maximum diameter of the lower portion of the body below the stop;
c. first and second sets of ribs, the first set of ribs being below the second set of ribs, the first set of ribs extending outwardly from the exterior wall of the body by a first distance, the second set of ribs extending outwardly from the exterior wall of the body by a second distance, the second distance being greater than the first distance;
d. a top portion of the exterior wall of the tool is hex shaped for engagement by a tool; and
e. an interior wall proximate to the bottom portion of the body comprises a hex shaped section.

16. A system for removing a sprinkler housing connected to a piping system, the system comprising:
a. the tool of claim 2;
b. a hollow tubular sleeve sized to receive at least part of the bottom portion of the tool body therein;
c. a stop on the exterior wall of the body of the tool between the upper portion and the lower portion, wherein the length of the stop is larger than the maximum diameter of the lower portion of the body below the stop; and
wherein the sleeve is configured to engage the stop so that rotation of the tool also rotates the sleeve.

17. A method for using the system of claim 10 to remove the sprinkler housing connected to a piping system, the method comprising the steps of:
a. placing the rod through the housing into the piping system;
b. placing the tool over the rod into the sprinkler housing wherein the tool is placed with the tool ribs engaging the internal sprinkler housing ribs; and
c. rotating the tool to release the sprinkler housing from the piping system.

18. A method for using the system of claim 12 to remove the sprinkler housing connected to a piping system, the method comprising the steps of:
a. attaching the removable mountable plug to the bottom of the body of the tool;
b. placing the tool into the sprinkler housing wherein the tool is placed with the tool ribs engaging the internal sprinkler housing ribs; and
c. rotating the tool to release the sprinkler housing from the piping system.

19. A method for using the system of claim 10 to remove the sprinkler housing connected to a piping system, the method comprising the steps of:
a. placing the tool into the sprinkler housing wherein the tool is placed with the tool ribs engaging the internal sprinkler housing ribs;
b. placing the rod through the tool body into the piping system; and
c. rotating the tool to release the sprinkler housing from the piping system.
